(19) United States
(12) Patent Application Publication
(10) Pub. No.: US 2003/0018396 A1
(43) Pub. Date: Jan. 23, 2003

(54) Method to create versatile controllers

(76) Inventors: Antonio Mugica, Boca Raton, FL (US); Carlos Alonso, Caracas (VE); Oscar Mora, Caracas (VE); Roger Pinate, Caracas (VE); Roberto Ponticelli, Caracas (VE); Jonathan Bartolotta, Antonio de Loas Altos (VE)

Correspondence Address: JEFFREY FURR, 253 N. MAIN STREET, JOHNSTOWN, OH, 43031, US

(21) Appl. No.: 09/682,092

(22) Filed: Jul. 18, 2001

(51) Int. Cl. G06F 3/00; G05B 19/18; G05B 11/01; G05B 15/00

(52) U.S. Cl. 700/17; 700/83; 700/2

(57) ABSTRACT

A method to design a controller is provided, considering controller“s versatility to work over any kind of layer 3 or layer 2 communication protocol and under any kind of control application. A programming language running on a system external to the controller considers a high level programming method. At the same time, the corresponding graphic interface needed to monitor a controller or a group of networking controllers is considered as a central program capable of communicating with the controller(s) in order to request for valuable data to monitor the control system and the process being controlled. Defining an object-oriented programming methodology the high level programming language as long as the centralized monitoring graphic interface can be abstract entities from the point of view of the controller(s) and vice versa. In order to abstract the controller from the type of selected communication protocol or control network working on layer 3 or layer 2, a network adapter is defined. The network adapter is a specialized device suitable to work with the selected communication protocol. Since the network adapter handles all network functions particular for the type of protocol, the controller only has to manage two primitive functions to send and receive data from/to the network.

### BACKGROUND OF INVENTION

1. BACKGROUND

2. DISCUSSION OF PRIOR ART

Automation and control systems are used today to handle several types of processes, varying from industrial processes, building or home security and automation, up to car security and monitoring, etc.

Independent from the type of involved process, there is always a programmable device, usually called controller, capable of executing the control and monitoring mechanism applied to such process. If a single controller is not enough to handle a complex process, a group of them can be joined together to provide the solution. A control network is then established to allow the communication between controllers, each one of them carrying out its own tasks but synchronizing control functions.

In order to monitor the control mechanism, a monitoring station is used. It is usually represented as a graphical interface located either local with the controller or as a remote console connected to the control network.

A controller is then a device comprising both hardware and software elements. FIG. 1 shows a block diagram of a generic controller 110. An application block 112 represents the software element. The application is a group of programming code made for a hardware 114, which represents the physical control equipment named before. The logic function or control algorithm defined by the user is programmed according to the capabilities of the hardware 114. Hardware 114 is the device responsible for the execution of the control algorithm and can be described by four main elements:. Central process unit (CPU) 116: Executes the logical and arithmetic operations.

Memory unit 118: Contains both volatile and non-volatile information. The volatile memory is represented by the Random Access Memory (RAM), which is used to store temporal calculation quantities and temporal execution code. The non-volatile memory is used to store the execution code, control parameters, identification numbers or any other information that must be permanently stored even if the controller is shut down.

Input/Output unit 120: This is controller“s interface to the process. The inputs take information from external sensor devices, which indicate the state or behavior of the process being controlled. The outputs generate the adequate signals according to the control algorithm in order to apply the control strategy.

Communication unit 122: This is the interface to the control network. This unit is responsible for the communication with other controllers or the monitoring console.

Finally, a network 124 provides the connection between controllers. In modern systems, a communication model called the OSI model represents network capabilities. This model is a seven-layer communication stack. It is called stack because each layer is located on top of another layer and each layer has its own defined functions according to different levels of abstraction. The lower four layers are necessary to ensure the integrity of the send data and will be discussed next.

The lowest layer is called physical layer. It describes the electrical characteristics of the transfer, the type of transmission media and the electrical representation of a binary piece of information. The next layer is the data link layer. It handles the arrangement of bits to define frames of information. It also takes care of the error correction in a frame transfer by adding an error correction code. Two sub-layers are defined into de data link layer: The Media Access Control (MAC) layer handles the way of sharing the physical media between all nodes present in the network, establishing a method to solve collisions and incomplete transfers. The link layer handles the physical addressing, defining unique identifiers for each node to send and receive frames. The third layer is the network layer. It defines logical addresses in order to identify nodes located either on the same network or on external networks. The fourth layer is the transport layer. This layer establishes logical connections between source and destination nodes and ensures order and integrity of the information.

Traditionally control networks have been considered as local networks. In this context the network layer is not needed since a controller network doesn“t need a dynamic logic address assignation. The hardware static addressing provided by the data link layer is enough. In the other hand, in a data-oriented network like the Internet, a logical addressing mechanism must exist to interconnect systems located on different local area networks. The physical, data link and transport layers must be always defined in a control network in order to obtain a reliable communication process.

It can be seen that a programmed application in a given hardware, interacting through a network with other controllers, contributes to the control solution to a given process.

It is desirable the existence of a general appliance controller, capable of handling a wide range of applications or control strategies working over a wide range of control networks using different types of protocols. Working with the controller model explained in FIG. 1, two factors must be taken care of in the method of designing such controller:

There must exist a simple mechanism to program and monitor a given application made to operate on the controller. Such mechanism involves programming and monitoring tools available to the user in the form of a programming language and a graphic user interface.

The internal operation of the controller must be independent from the type of network or communication protocol being used to connect with other control devices.

In the recent past there has been different approaches to the first factor, by including a high level programming language in the controller as the native programming tool (e.g. U.S. Pat. No. 6,201,996). It proposes the inclusion of a web server into the controller capabilities in the form of hardware and software adequate to provide web services. A web page is downloaded from the controller (server) to a personal computer (host) to provide monitoring services. Such design has some consequences, has listed next

The hardware and software needed to manage a web page increase controller“s complexity and hence the cost. If the target is to design a simple, low-cost controller to build a distributed control network using several controllers, this is not the best solution.

By using web server capabilities working with the TCP/IP transport and network layer protocols the controller is limited to work with IP addressing. Any other type of network layer protocol using a simpler addressing mechanism is not considered, limiting controller“s networking flexibility.

In order to monitor the control network each controller is considered as an independent web server containing a web page. Even when a link present in the web page can be used to call another web page located in a remote controller, a distributed monitoring mechanism is proposed. Placing independent graphic interfaces on each controller limits the possibility to create centralized, easy to use monitoring stations suitable to be used by an operator.

The presence of several independent web pages running on each controller doesn“t allow complex changes to the monitoring interface. In order to make a change all web pages involved in such change must be reloaded in its respective controller, instead of using a central monitoring station where the monitor system could be partially or totally changed at once.

In the other hand, a solution to establish a control network using different types of networks proposes the inclusion of communication routines as part of the source code of the controller. The controller, represented by an 8 or 16-bit microcontroller, is then made suitable to communicate with a personal computer working as a gateway both to other controllers and to the Internet (emware, Inc. Salt Lake City, Utah). With this approach specific communication libraries are provided to the user in accordance to the model and manufacturer of the microcontroller. In order to support different kinds of communication standards, like RS232, RS485, Ethernet, or modem dial-up, a particular set of routines are defined for each standard. With this method, network capabilities of the device are directly included into the assembly code of the microcontroller responsible for the control strategy. It makes impossible changing the type of communication network without recompiling and reloading the entire code representing the control application. In this case the controller doesn“t have the flexibility to work with different kind of networks without changing or reloading the control application.

### SUMMARY OF INVENTION

A method to design a versatile controller considering three levels of abstraction is defined. At the bottom lies the control network representing the first level, followed by the controller (second level), which executes the control strategy over a given process, and finally the programming language or programmer interface along with the graphic user interface (third level) suitable to monitor the control system. Adequate interfaces are defined between these three levels in order to make a level independent from its neighbor(s).

Versatility from the programmer interface to the controller is accomplished defining an object-oriented programming strategy, where an object is a block function responsible for carrying out specific functions into the controller. A group of interacting objects are connected with each other in a high level programming language to define a control application. The application is compiled according to specific code instructions suitable to controller“s hardware, which is capable of decoding the compiled set of objects in order to execute the function comprised by each object. Every information needed by the monitor station is provided from the controllers by included objects whose function is to maintain updated information. The monitoring station contains a Monitoring Graphic User Interface, which is able to request and receive valuable information from the existent controllers in the control network to display it as a graphical representation to the human operator.

Versatility from the controller to the control network is made with the inclusion of an external device (Network Adapter) between both elements and it“s responsible for handling the lower four layers of the OSI communication model. The controller only handles two primitive network functions (Send and Receive) in order to communicate with other controllers. The network adapter contains hardware and software needed to specifically manage the selected type of layer 3 or layer 2 communication protocol. A logic identifier corresponding to the destination controller is given to the network adapter in a call to the Send primitive. The network adapter is responsible of mapping the logic identifier with the layer 3 or layer 2 address corresponding with the destination controller to finally send the information to the control network.

OBJECTS AND ADVANTAGES

Accordingly, several objects and advantages of the present invention are: a) To define a method to abstract the control application programming and the monitoring graphic user interface from the controller native programming language, in order to allow the existence of any kind of control application into the controller, independent from the programming language or the monitoring station.

b) To define a method to abstract the controller from the type of control network, in order to allow the functioning of the controller over any kind of layer 3 or layer 2 communication protocol or network.

Other objects and advantages of this invention will become apparent from a consideration of the ensuing description and drawings.

### BRIEF DESCRIPTION OF DRAWINGS

FIG. 1 Shows the elements related to a generic controller.

FIG. 2 Shows the elements defined in FIG. 1 along with the elements defined for this invention.

### LIST OF REFERENCE NUMERALS IN DRAWINGS

110 Generic controller

112 Application or control strategy programmed in controller 110

114 Hardware comprising controller 110

116 Central Processing Unit of hardware 114

118 Memory unit, volatile and non-volatile memory of hardware 114

120 Input/Output unit of hardware 114

122 Communication unit of hardware 114

124 Generic control network 210 Operative System in controller 110

212a, 212b, 212n Software micro-objects

214 Application code 216 High level language compiler

218 Micro-objects library

220 Graphic User Interface

222 Monitoring Graphic User Interface

224 Network Adapter

### DETAILED DESCRIPTION

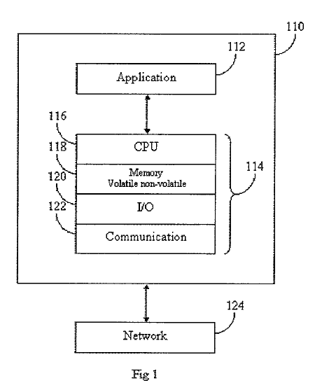

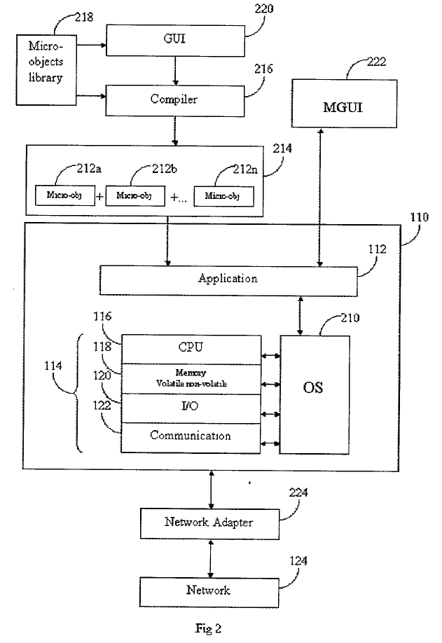

The generic controller containing the elements shown on FIG. 1 is considered as a basic design comprising application 112 loaded on hardware 114. Both hardware and software elements can work in a networking environment using the generic network 124. Network 124 is considered as any layer 2 or layer 3 communication protocols.

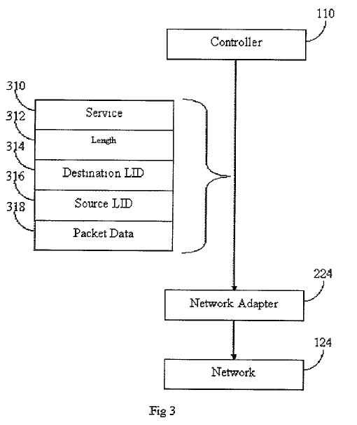

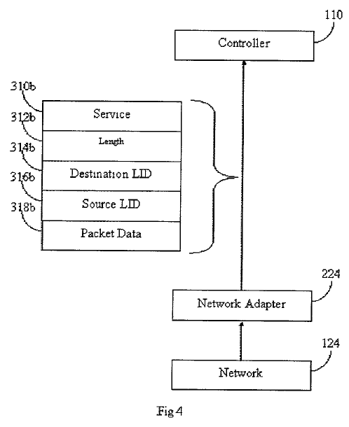

In order to design a versatile controller, it must be an abstract entity to the control network. At the same time, the control application and the monitoring interface must be two abstract elements programmed in high level languages in order to create an abstract level between software and hardware. Such abstraction is accomplished by the inclusion of interfaces between those three elements (software, hardware and network). FIG. 2 shows the preferred embodiment for this invention.

Application—Controller Interface

A traditional method to program a controller implies the programming of a set of instruction according to the particular controller. It requires programming experience applied to the particular programming language. In the same manner, adequate routines must be included in controller“s executing program in order to monitor to monitor alarms, states, quantities, etc, related to the controlled process.

Modern programming methods consider the creation of abstract elements called objects. An object is a software entity, which represents a concept. An object contains defined data structures that can“t be directly modified. Those structures contain data fields, which define the object attributes. The definitions of methods applied to each particular object allow the programmer to interact with the content of the structure fields, not the structure itself. Furthermore, basic objects can be part of a more complex object, establishing a hierarchical structure where parent objects can call children objects to accomplish a task. For example, an automatic sliding door could be represented as a software object in the form of the object Door. The object Door is represented by a structure with two fields called Position and State. Position is a variable indicating a percentage where 0% means the door is closed and 100% that is fully open. State is a binary variable indicating if the door is or isn“t locked, being possible or not its movement. Two methods could be associated to the door. Those methods are Open and Close. They include an input value indicating the percentage the door must be opened or closed. Additionally, in order to physically execute both methods, a children object called Motor with methods Forward and Back is called in order to make the door move in any direction.

The object-oriented programming strategy is considered for this invention, which comprises the calling of objects and methods instead of dedicated functions. The inclusion of objects provides a more structured methodology adding a new abstraction level, as will be explained later.

Looking at hardware 114 on FIG. 2, an Operative System (OS) 210 is considered here as a logic program running on the controller responsible for the administration of the available resources named before. It administrates the CPU 116 usage to make operations, assigns memory resources 118 according to application 112, and controls I/O and communication resources 120 and 122 respectively.

The OS is responsible for the correct execution of application 112. Application 112 is made with a group of interacting micro-objects (mO) (212a, 212b, 212n). A mO is a software object created using the machine-instruction code corresponding to the hardware 114. A mO comprises a series of instructions executing a particular function, which consumes available resources. For example, in an access control application, a mO called Card with two related methods called Number_in and Search are used to read a card number first and then look for that number in memory. The method Number_In involves the use of communication resources 122, since the card value is taken from an external card reader. The method Search makes use of memory resources 118 to look for the valid card number.

Based on the native programming instruction and hardware resources of controller 110, a micro-objects library 218 is created, containing several types of mO, each one with its own methods and capabilities to establish execution relations with other micro-objects. In hardware 114, OS 210 is the logic entity capable of decoding the structures and methods associated with each mO, assigning resources to the execution of the corresponding methods.

In a high level-programming environment, a Graphic User Interface (GUI) 220 is provided to the programmer or user to build an application using a graphic interface. The user will have the micro-objects library 218 to program a high level application, taking a subset of the available mO in the form of block functions. Using the inputs, outputs, methods and relations between micro-objects the programmer is able to construct the control strategy. A compiler 216 generates a corresponding application code 214 in the form of executable instructions representing the micro-objects suitable to hardware 114. Application code 214 is downloaded to controller 110 either through control network 124 or through a dedicated local connector present in controller 110. OS 210 will finally be responsible for the execution of application 112 stored in the non-volatile memory.

In order to provide adequate monitoring tools a Monitoring Graphic User Interface (MGUI) 222 is defined. As shown on FIG. 2, it has a direct relation with application 112. This can be done taking previous considerations in the application programming process explained before.

Micro-objects library 218 contains all objects capable of carrying out all control functions suitable to controller 110. A controller function is not limited to execute the programmed control algorithm. It also must be capable of reporting updated functioning status, variable states, alarm conditions, or any other information required by the operator, adequate to supervise both the control system and the process being controlled.

A group of micro-objects is defined to input control commands or requests and to output status, quantities or responses. Those monitoring micro-objects are included at will by the programmer according to the desired states or values that must be supervised. All needed monitoring micro-objects are included in the programming phase made on GUI 220 and are compiled together with micro-objects 212 responsible for the control strategy. Application 112 will be able to communicate with a remote monitoring station containing MGUI 222 using the micro-objects dedicated to monitoring functions.

In a preferred embodiment MGUI 222 is considered as a program running on a personal computer capable of communicating with the monitoring micro-objects included in controller 110. Physically the personal computer communicates through control network 124 with all existing controllers and collects information from each one of them. The gathered information is ordered to finally show it as a unified and coherent graphic display.

All information requested is interpreted in the personal computer containing MGUI 222 and not in controller 110. Controller 110 is just responsible for answering the information requests for which it was programmed. Short burst of information containing simple data will be traveling from the personal computer to a given controller and backward. Any further processing of the requested data is made into the personal computer. Such further processing could be, for example, assign a particular format to the data, changing the display properties according to received value or state, requesting for another information based on the actual value, etc. Utilization of an object-oriented strategy separates application programming from the type of controller used. To the user exists a library of objects with relations to connecting them. To the controller exists a group of mO in the form of executable code that will be managed by OS 210. In the case of changing controller 110, GUI 220 and micro-objects library 218 is maintained. A new set of mO 212 programmed to the new hardware will contain methods and data structures analogue to the old set of mO 212. A new compiler will be responsible to convert the same object calls made in the high-level programming environment to the new set of mO. An effort must be made to define a wide variety of mO in order to allow the existence of more complex control applications.

Furthermore, by using micro-objects to maintain constant communication with the supervisory station, the graphic interface available to the operator is isolated from the type of used controller. MGUI 222 only has to communicate with micro-objects present 212 on controller 110 dedicated to provide the requested information. Controller 110 doesn“t need to contain any special function or routine to provide a final user interface suitable to the operator. Instead, it only has to deal with the programmed objects responsible to update information required by MGUI 222.

With this structure MGUI 222 can increase its complexity independent from the processing power of the available controllers, since all processing power related to monitoring matters is unified into the personal computer while the control strategy is distributed through the available controllers. It means that in the case of failure of MGUI 222 the control network would still work fine, but without the presence of the monitoring station.

MGUI 222, being a central entity, can also be changed without modifying the application contained on each controller, maintaining only the same calls to the monitoring micro-objects present on each one of them.

Controller—Control Network Interface

As shown on FIG. 2, a network adapter 224 must be added in order to provide network capabilities. As was said before, the four lower layers of the OSI model are needed to obtain a reliable communication. Network adapter 224 is a device independent from controller 110 responsible for handling all communication layers needed to provide a reliable data transfer.

From the point of view of controller 110, there are only two primitive functions related to network adapter 224, called Send and Receive. A Logic ID (LID) is assigned to each controller as part of a data field stored in a mO dedicated to network functions. As shown on FIG. 3, a method of a mO involving data transmission to another controller is made by calling the primitive Send with four parameters: Service 310, Length 312, Destination LID 314 and Source LID 316. Service 310 indicates if the packet must be sent using a reliable mechanism or an unreliable mechanism. In a reliable context, a data packet is sent and an acknowledge indication generated by network adapter 224 working in the destination controller is expected. If such indication is not received in a certain amount of time network adapter 224 can either send the packet again or return a send error to controller 110. In an unreliable service an acknowledge indication is not expected and the packet can be lost in the transfer process.

Length 312 indicates the size of the information to be transmitted, so network adapter be able to reserve memory space to receive the information.

Destination LID 314 and Source LID 316 are the destination controller and the source controller 110. Destination LID 314 is a high-level representation of a controller that can be referenced in application 112. There is always a low-level address corresponding to communication layer 2. As was said before, this physical address is related to the hardware involved in the data transfer. Network adapter 224 must contain a mechanism to map each Destination LID 314 indicated in a Send primitive with the associated hardware address. Those skilled in the art must recognize existing mechanism to accomplish this task, for example, the Address Resolution Protocol, which is used to obtain a hardware address having the logic address.

In the case of a layer 3 protocol, network adapter 224 must also contain a mechanism to map Destination LID 314 with the corresponding logic address and hardware address, corresponding to communication layers 3 and 2, respectively.

An incoming data packet is received by calling the primitive Receive, as shown on FIG. 4. Network adapter 224 must then return a similar structure, denoted by b suffixes, used in the Send primitive. The remote controller (not shown) is responsible for filling the fields to be received by controller 110.

As can be seen, when the user programs an application only the source and destination LID must be known. Network adapter 224 is independent from controller 110, so it can be changed without reloading or reprogramming the controller.

### CONCLUSION, RAMIFICATIONS AND SCOPE OF INVENTION

Thus, the reader will see that the design considerations shown before define a versatile controller, where versatility is considered as: controller“s capabilities to execute any kind of control application, according to an object-oriented programming model; controller“s capabilities to communicate with a monitoring station and; controller“s capabilities to work on top of any layer 3 or layer 2 network.

The adoption of an object-oriented methodology abstracts the high level programming language and the final monitoring graphic interface from the considered controller, being possible the substitution or modification of any of those three elements without affecting the other two.

The inclusion of an external network adapter creates a gap, which abstracts the controller from the control network. The network adapter creates such gap taking all responsibility for particular network management functions applied to the selected type of network.

While our above description contains many specificities, these should not be construed as limitations to the scope of the invention, but rather as an exemplification of one preferred embodiment thereof. Obviously, modifications and alterations will occur to others upon a reading and understanding of this specification.

The description above is intended, however, to include all such modifications and alterations insofar as they come within the scope of the appended claims or the equivalents thereof.

What is claimed is:

1. An object-oriented controller in which abstraction is accomplished by the incusion of interfaces between the hardware, software and network elements, the controller comprising: a. Hardware with with a processing means using an operative system that runs an application, said application made of a plurity of micro-objects from a micro-object library, a memory means, an Input/Output means and a communication means; b. a Monitoring Graphics User Interface interfacing to a plurality of hardware through said hardware“s application; and c. a network adapter that receives from and sends data to a plurality of hardware through said hardware“s communication means.

2. The controller of claim 1 wherein the communication from the hardware to the network adapter consists of a send and receive function.

3. The controller of claim 1 wherein the communication from the hardware to the network adapter consists of a send and receive function with a logical ID being assigned to each hardware and the send function using four parameters;
Service, whether an acknowledgement is needed;
Destination hardware;
Source hardware; and
Length, which is the length of the data packet to be communicated.

4. The controller of claim 1 wherein the Monitoring Graphics User Interface is used to download the application to the hardware.

5. The controller of claim 1 wherein the Monitoring Graphics User Interface is contained on a computing means.

6. The controller of claim 1 wherein the Monitoring Graphics User Interface is contained on a computing means and interfaces to a plurlarity of hardware through the Network Adapter.

7 The controller of claim 1 wherein the Network Adapter contains a mapping means to map a Destination address with the corresponding logic and hardware address.

8. The controller of claim 1 wherein the micro-object library is created with a plurality of micro-objects each with each own methods and capabilities.

9. The controller of claim 1 wherein when changing hardware, a new set of micro-objects for the new hardware will be used that will contain methods and data structure analogue to the old set of micro-objects used by the old hardware.

10. A method for an object-oriented controller comprising the step of: a. Using a Hardware means with with a processing means using an operative system that runs an application, said application made of a plurity of micro-objects from a micro-object library, a memory means, an Input/Output means and a communication means; b. Using a Monitoring Graphics User Interface for interfacing to a plurality of hardware through said hardware“s application; and c. Using a network adapter that receives from and sends data to a plurality of hardware through said hardware“s communication means.

12. The method of claim 10 wherein the communication from the hardware to the network adapter consists of a send and receive function.

13. The method of claim 10 wherein the communication from the hardware to the network adapter consists of a send and receive function with a logical ID being assigned to each hardware and the send function using four parameters;
Service, whether an acknowledgement is needed;
Destination hardware;
Source hardware; and
Length, which is the length of the data packet to be communicated.

14. The method of claim 10 which includes using the Monitoring Graphics User Interface to download the application to the hardware

15. The method of claim 10 which includes containing the Monitoring Graphics User Interface on a computing means.

16. The method of claim 10 includes containing the Monitoring Graphics User Interface on a computing means and interfacing to a plurlarity of hardware through the Network Adapter.

17 The method of claim 10 which includes having the Network Adapter contain a mapping means to map a Destination address with the corresponding logic and hardware address.

18. The method of claim 10 which includes creating the micro-object library with a plurality of micro-objects each with each own methods and capabilities.

19. The method of claim 10 wherein when changing hardware, a new set of micro-objects for the new hardware will be used that will contain methods and data structure analogue to the old set of micro-objects used by the old hardware.
